(19) United States
(12) Patent Application Publication
(10) Pub. No.: US 2011/0089767 A1
(43) Pub. Date: Apr. 21, 2011

(54) ARRANGEMENT RELATED TO OFFSHORE CABLE SYSTEM

(75) Inventors: Svend Rocke, Lier (NO); Per-Thomas Bjørgan, Oslo (NO); Espen Haugs, Sperrebotn (NO)

(73) Assignee: Vetco Gray Scandinavia AS, Sandvika (NO)

(21) Appl. No.: 12/933,138

(22) PCT Filed: Mar. 17, 2009
(86) PCT No.: PCT/IB09/00540

§ 371 Date: Jan. 5, 2011

(30) Foreign Application Priority Data
Mar. 17, 2008 (NO) 20081392

(51) Int. Cl. H02J 3/22

(52) U.S. Cl. 307/102

(57) ABSTRACT

A method for measuring a capacitance using a capacitance meter. The capacitance meter includes an AC power source with a controllable frequency which is fed to a capacitor to measure its capacitance. A first measurement of the capacitance is performed by the capacitance meter using a first frequency. When the first measurement of the capacitance indicates the capacitance is below a threshold capacitance a lower capacitance measurement is performed in the capacitance meter, using a second measurement of the capacitance using a second frequency. When the first measurement of the capacitance indicates the capacitance is above a threshold capacitance, a higher capacitance measurement is performed in the capacitance meter, using a second measurement of the capacitance using a third frequency, the third frequency being lower than the second frequency.

### TECHNICAL FIELD

The present invention relates in general to an electric power distribution system and is more particularly concentrated towards an arrangement thereto.

The present invention has its application to an offshore cable system, preferably to an arrangement within a submarine cable system.

According to the present invention said arrangement is adapted to offer dynamic resonance tuning and voltage regulation, for adaptation to a momentary load situation and/or stabilisation.

Said cable system is usually a three-phase electric power transmitting system, which normally uses one or more transformer units to transform a first voltage value to a second higher voltage value or vice versa.

Said system is thus adapted for electric power transmission and is in this application illustrated with a power supplying means in the form of a variable speed drive means and a consumer means in the form of an electric motor or the like.

The system is based on the use of a power transmission line, at least partly, in the form of an offshore cable, preferably a submarine cable, exposing circuits for compensating for and/or for reducing generated resonance frequencies.

Such frequencies depend on the construction of said speed drive means and its components, the transmission criteria for the submarine cable utilized, the chosen length of said cable, any transformer units adapted to said transmission cable, said consumer means and its components and/or a chosen frequency.

Said prior art circuit is adapted to include one or more components related to the term “primary parameters”, in the following exemplified as resistance values having one or more components, capacitance values having one or more components, inductance values having one or more components or a combination of these components to form impedance values.

### BACKGROUND OF THE INVENTION

Methods and arrangements of the above-outlined nature are previously known in the art in a plurality of different embodiments of subsea or submarine adapted arrangements, related to or including a submarine cable system, adapted for long range electric power transmission.

A previously known arrangement, related to an offshore, cables and transformer units including, system, wherein said system being adapted for electric power transmission over three phases, is here illustrated with a power supplying means, and a power receiving means illustrated here in the form of an electric motor, that over a power transmission line, at least partly, in the form of an offshore cable, comprises circuits and components for compensating for and/or reducing generated resonance frequencies.

This resonance frequency depends on the cable used, the length of said cable, any transformer units used adapted and related to said transmission line, said consumer means and/or a chosen frequency, said circuit being adapted to enclose one or more primary parameters, such as resistance, capacitance and/or inductance value related components and having fixed or adjustable values.

It is also known, in an application significative to the present invention, that the maximum distance of a power transmission line within a system including a variable speed drive for driving a motor, is limited by otherwise occurring voltage drops, current limitations and/or cable resonance frequencies.

It has been recognized that if a chosen distance or length of the cable is too great or too long, said voltage drop will cause stability problems and challenges. This is especially the case if the system exposes characteristics relevant to or close to a so called “nose point” (maximum effect) of the system.

This will also cause a capacitive charging current higher than that of the current carrying capabilities of the cable used.

Cable resonance effects will also limit the maximum distance as too long a distance will give cable resonance within a transmission frequency range creating a series or parallel impedance “blocking” of the power transmission at the transmission line resonance frequencies.

As the base operation frequency varies within the range from approximately 0.1 Hz to several hundreds of Hz it has been found that the harmonics may vary at least from 0.2 Hz and up to the range of kHz.

It has been found that if one or more of the harmonics is to coincide with one of the power system related resonance frequencies this will result in a generated over-current or an over-voltage, such high values for the current or voltage may damage the relevant transmission system.

It has been proposed to handle these over-current and/or over-voltage situations by introducing components that have a filtering effect on said harmonics.

Taking into consideration the characteristic features related to the present invention causing a change of the values of the utilized dynamic controllable inductor and its components in said circuit (shown in FIG. 2), the principles linked to this are already partly known per se.

Examples of this technology are shown and described in the following US patent publications; U.S. Pat. No. 6,933,822-A; U.S. Pat. No. 7,193,495-A; U.S. Pat. No. 6,956,291-A; U.S. Pat. No. 7,026,905-A; U.S. Pat. No. 7,256,678-A; U.S. Pat. No. 6,788,180-A; U.S. Pat. No. 7,061,356-A and U.S. Pat. No. 7,259,544-A.

The principles disclosed in these patent publications may be used in forming and activating the impedance values “Z”, illustrated in FIGS. 2 and 3.

As a part of the prior art it is to be mentioned the patent publication WO 2005/076 293 A1 which is directed to a power supply control method, devices and systems.

One embodiment is here suggested to be implemented by means of a transformer, with a primary winding (PW), and a secondary winding (SW) for a connection to a variable load (VL) and a magnetic flux path.

Here a transformer (T) is shown as comprising a common member (CM) and a by-pass member (BM), which provide for first (1) and second (2) flux paths.

In said transformer the first flux path (1) is related to the primary winding (PW) and the secondary winding (SW) and the second flux path (2) is a by-pass flux path for leakage flux.

At least one of the flux paths has controllable relative permeability.

It is here suggested the control of the power supplied to different types of loads.

In another embodiment it is suggested to limit the current, for example a short circuit current.

In a further embodiment it is suggested to control the power supply to circuits exposing capacitive load, to avoid resonance problems, which may occur in such circuits.

It is further here suggested the introduction of an inductive element with a controlable permeability, and especially controlling power or voltage drop at a variable load and/or limiting a current through a variable load.

It is further suggested that, upon variations in the load impedance, adapting to the power transferred to the load to a new load impedance or maintaining, the voltage drop in the load impedance is substantially unchanged by;
a. changing the effective permeability of the common flux path to change the common flux or
b. changing the effective permeability of at least one by-pass flux path to change the leakage flux or
c. changing both the effective permeability of the common flux path and the effective permeability of the bypass flux path to change the common flux and the leakage flux.

The patent publication US 2003/0 117 228 A1 is showing and disclosing a circuit component (L1) with a controllable impedance, comprising a body (1) of magnetisable material, a main winding (A1), wounded round the body (1) about a first axis, and a control winding (A2), wounded round the body (1) about a second axis, at right angles to the first axis.

The main winding (A1) is arranged for connection to a working circuit in which the circuit component (L1) is to be employed and the control winding (A2) is arranged for connection to a control unit, for controlling the impedance in the working circuit.

This arrangement may also be related to various current and voltage regulating devices, comprising the circuit component or a similar transformer device.

As a summary of the technique, disclosed in the above mentioned prior art publications, there is shown and described a power supply arrangement, using different flux paths in a transformer or the like for adapting the power supply to the instant load conditions.

### CONSIDERATION OF THE PRESENT INVENTION

### Technical Problems

Considering the circumstance that the technical deliberations that must be made by a person skilled in the art to be able to offer a solution to one or more technical problems posed is, on the one hand, initially a necessary insight into the measures and/or sequence of measures to be adopted and, on the other hand, a necessary selection of the means required, the following technical problems are likely, in view hereof, to be relevant in the evolution of the structure and arrangement according to the present invention.

Considering the state of the art, as described above, it should probably therefore be seen as a technical problem to be able to realise the importance of, the advantages associated with and/or the technical measures and considerations which will be required in order to, in an arrangement related to or included in an offshore system, preferably a submarine system including cables and transformer units, cause adaption for electric power transmission from a power supplying means in the form of a variable speed driving means to a consumer means in the form of an electric motor or the like, over a power transmission line or cable, at least partly in the form of an offshore cable, comprising a circuit for compensating for and/or reducing generated resonance frequencies, depending on said speed drive means and its components, a utilized transmission cable, the length of said cable, any used transformer units and their components adapted to said transmission line or cable, said consumer means and/or a chosen frequency and/or chosen voltage and/or current values, and wherein said circuit is adapted to enclose one or more controlled primary parameters in the form of resistance-, capacitance- and/or inductance-related variable values and components related thereto.

There is a technical problem in being able to realise the importance of, the advantages associated with and/or the technical measures and considerations which are derived from having a control means related to said circuit, wherein said control means is adapted to control and adjust one or more dynamic components, corresponding to one or more of said primary parameters, by changing the values of said one or more dynamic components in dependence of momentary voltage and/or current values detected at said consumer means and/or adjacent said means and/or said circuit.

There is a technical problem in being able to realise the importance of, the advantages associated with and/or the technical measures and consideration, which are derived from said circuit being adapted to change the resonance frequency of the power transmission cable to avoid any sort of power transmission blocking.

There is a technical problem in being able to realise the importance of, the advantages associated with and/or the technical measures and consideration, which are derived from said circuit being adapted to cause or generate dynamic phase compensation in order to reduce power loss related to the transmitting cable and associated circuits.

There is a technical problem in being able to realise the importance of, the advantages associated with and/or the technical measures and consideration which are derived from said circuit being adapted to cause or generate maintenance of a minimum voltage level at said consumer means, even during a suddenly appearing load variation, an increase or a decrease in the load.

There is a technical problem in being able to realise the importance of, the advantages associated with and/or the technical measures and consideration which are derived from said control means including voltage and/or current sensing means adapted to sense said voltage and/or current at or adjacent said consumer means and responsive to a control signal generated by a main control means to control and set the value of one or more impedance exposing components within said circuit.

There is a technical problem in being able to realise the importance of, the advantages associated with and/or the technical measures and consideration, which are derived from said impedance exposing components within said circuit being connected between phase lines or conductors in a three-phase transmission cable, between each phase and zero (or ground) potential and/or in series with said three-phase lines.

There is a technical problem in being able to realise the importance of, the advantages associated with and/or the technical measures and consideration, which are derived from said control means exposing circuit components adapted to determine actual voltage and/or current values directly or indirectly related to said consumer means.

There is a technical problem in being able to realise the importance of the advantages associated with and/or the technical measures and consideration which are derived from said offshore cable system, comprising: a frequency converter, as said variable speed drive means; a main control means including memories and computer arrangements connected to said frequency converter; any first transformer unit, an offshore control means connected to said main control means, to receive information-carrying signals from said main control means and to send information-carrying signals to said main control means; circuits for compensation for resonance frequencies; any second transformer unit; and said consumer means in the form of a motor or the like.

There is a technical problem in being able to realise the importance of, the advantages associated with and/or the technical measures and consideration, which are derived from said motor being adapted to expose a revolution rate or speed (rpm) depending on an applied load and voltage and a relevant frequency.

### Solution

The present invention thus takes as its point of origin or starting point an arrangement, related to an offshore system, preferably a submarine system including cables and transformer units, adapted for electric power transmission from a power supplying means in the form of a variable speed drive means to a consumer means in the form of an electric motor or the like over a power transmission line, at least partly in the form of an offshore cable, comprising a circuit for compensating for and/or reducing generated resonance frequencies, depending on said speed drive means, utilized transmission cable, the length of said cable and any used transformer units adapted to said transmission line or cable, said consumer means and/or a chosen frequency, said circuit being adapted to enclose one or more primary parameters (resistance-, capacitance- and/or inductance-related components).

In order to be able to solve one or more of the above-outlined technical problems, the present invention proposes that a control means and/or adjusting means is related to said circuit and that said control means is adapted to control and/or adjust one or more discrete dynamic components, corresponding to one or more of primary parameters, by changing a resistance value, a capacitance value and/or a inductance value of said one or more dynamic components in dependency of momentary voltage and/or current values, detected at said consumer means and/or adjacent said means and/or circuit.

As suggested embodiments, which fall within the scope of the inventive concept of the present invention, it is proposed that said circuit is adapted to change the resonance frequency of the power transmission cable to avoid a power transmission blocking.

It is further proposed that said circuit is adapted to cause or generate dynamic phase compensation to reduce power loss related to the transmission cable and associated circuits.

It is also proposed that said circuit is adapted to cause or generate maintenance of a minimum voltage level at said consumer means, even during a suddenly appearing load variation.

Said control means further includes voltage and/or current sensing means adapted to sense said voltage and/or current at or adjacent to said consumer means and responsive to a control signal, generated by a main control means to control and set the value of one or more impedance comprising components in said circuit.

Said impedance comprising components within said circuit are connected between phase lines or conductors in a three-phase transmission cable, between each phase and zero (or ground) potential and/or in series with said three-phase lines.

According to the present invention said control means comprises circuit components adapted to determine actual voltages and/or current values related to said consumer means.

Further it is proposed and suggested that said offshore cable system shall include; a frequency converter as said variable speed drive means; a main control means, including memories and computer arrangements connected to said frequency converter; any utilized first transformer unit; an offshore control means connected to said main control means to receive information-carrying signals from said main control means and to send information-carrying signals to said main control means; circuits for compensation for resonance frequencies; any second transformer unit; and said consumer means in the form of a motor or the like.

Said motor is adapted to expose or maintain a number of revolution (rpm) based on applied voltage and relevant frequency.

### ADVANTAGES

The advantages which may principally be considered as significant for an arrangement related to an offshore system, preferably a submarine system, including cables and transformer units, adapted for an electric power transmission, from a power supplying means in the form of a variable speed driving means to a consumer means in the form of an electric motor or the like, over a power transmission line or cable, at least partly in the form of an offshore cable, said arrangement comprising a circuit for compensating for and/or reducing generated resonance frequencies depending on said speed drive means; a transmission cable utilized; the length of said cable and any transformer units, if such are utilized, adapted to said transmission line or cable; consumer means; and/or a chosen frequency; said circuit being adapted to enclose one or more primary parameters in the form of resistance, capacitance and/or inductance components.

The most significant features, linked to the present invention, offer the utilisation of an offshore control means related to said circuit, said control means being to control and adjust one or more dynamic components, corresponding to one or more of said primary parameters, by changing the value of said one or more dynamic components in dependence of momentary voltage and/or current values, detected at said consumer means and/or adjacent said means and/or circuit.

The present invention suggests an adapted changing of the cable system resonance frequencies by changing and regulating the values of one or more of the primary parameters by using said control means that are adapted to respond to information-carrying signals sent from a main control means.

The subject matter which may principally be considered as characterising the present invention is disclosed in the characterising part of the appended claim 1.

### BRIEF DESCRIPTION OF THE ACCOMPANYING DRAWINGS

A prior art arrangement or structure completed in accordance with the disclosures of the present invention will now be described in greater detail in the following with reference to the accompanying drawings. In the accompanying drawings:

FIG. 1 is a schematic view of a system comprising a submarine cable for electric power transmission, from a power supply means having a variable speed drive to a consumer means, said system showing an arrangement, according to the novel features linked to the present invention and with a voltage/power graph illustrated above said consumer means,

FIG. 2 shows a graph of the impedance variation in relation to frequency for a submarine cable, utilized in the present invention and illustrating impedance maximum and impedance minimum appearing at different frequency values,

FIG. 3 is a simplified circuit diagram of an arrangement and its circuit and its components for compensating for resonance frequencies and including said dynamic primary components and its control means,

FIG. 4 is a simplified block diagram representing a control means related to said arrangement, its circuit and its components, and

FIG. 5 is a simplified block diagram representing a main control means related to said variable speed drive means.

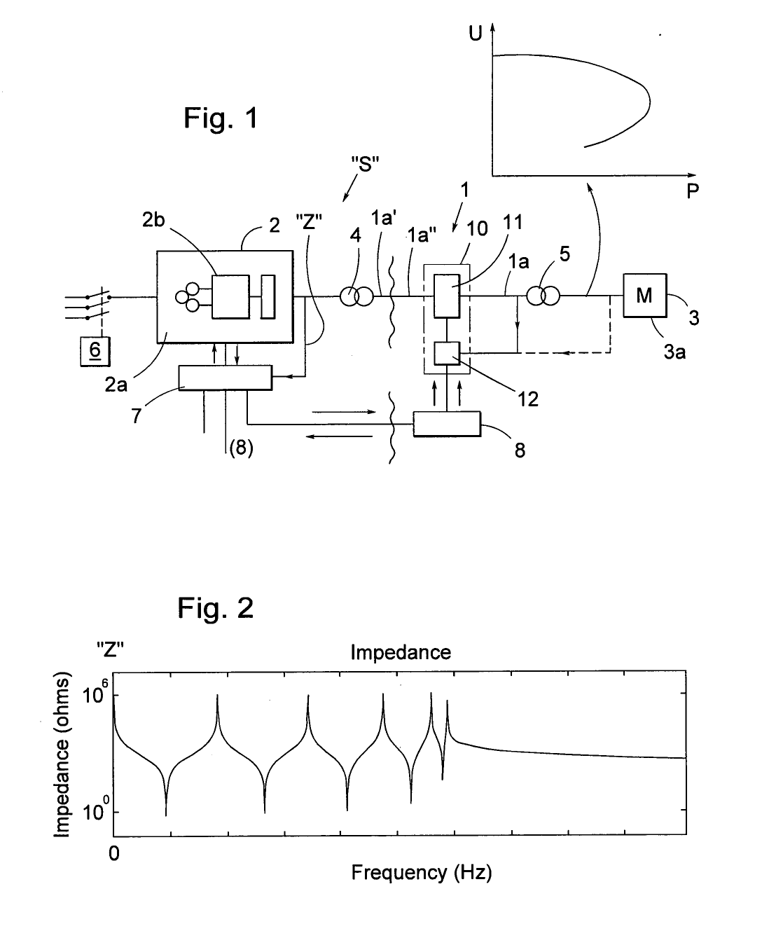

### DESCRIPTION OF THE PRIOR ART EMBODIMENT, IN ACCORDANCE WITH SELECTED PARTS OF FIG. 1

With reference to FIG. 1 it is illustrated in a schematic view a submarine cable exposing system “S”, for electric power transmission from a power supply means 2 having a variable speed drive means 2a to a consumer means 3.

A system “S”, adapted for an electric power transmission from said power supplying means 2, is illustrated here in the form of a variable speed drive means 2a, to a consumer means 3, in the form of an electric motor 3a or the like, over a power transmission line 1 at least partly in the form of a submarine cable 1a and its submarine cable section 1a″.

Said system shows circuits and components for compensating for and/or reducing generated resonance frequencies, depending on said speed drive means 2a; a transmission line 1 utilized in the form of a cable 1a; the length of a cable utilized; any transformer units 4, 5 utilized and adapted to said transmission line 1; said consumer means 3; and/or a chosen frequency; a circuit 11 adapted to enclose one or more primary parameters, in the form of resistance components, capacitance components and/or inductance components and their values utilized here.

### Description of a Currently Proposed Embodiment

It should be emphasized by way of introduction that, in the following description of a currently proposed embodiment which displays the significative characterising features related to the present invention and which is clarified by means of the figures shown in the accompanying drawings, we have selected terms and special terminology with the sole intention principally of clarifying the inventive concept.

However, in this context it should be observed that the expressions selected here should not be considered as restrictive exclusively to the terms selected and utilised here but it should be understood that each thus selected term is to be interpreted so that, in addition, it encompasses all technical equivalents which function in the same or substantially the same manner in order thereby to be able to attain the same or substantially the same intention and/or technical effect.

With reference to FIG. 1 is shown the introduction of an arrangement 10 in the electric power transmission line 1 or cable section 1a″, and although FIG. 1 shows said line 1 or said cable section 1a″ as a single line, it is to be noted that these single lines represent a three-phase electric power transmitting system “S”.

The present invention has as its purpose to offer dynamic resonance tuning of the system “S” and voltage stabilisation at the consumer means 3 more or less independently of the relevant load to the motor 3a, which may take the form of a liquid pumping equipment.

FIG. 1 illustrates a current breaker unit 6, a main control means 7, related to a frequency converter unit 2b, located in variable speed drive means 2a, which via two-way information-carrying channels cooperates with said main control means 7. These two information-carrying channels are illustrated in the Figures as a single line.

Said main control means 7 is, via two-way information-carrying channels, in cooperation with control means 8, whose single line is marked with two-way arrows.

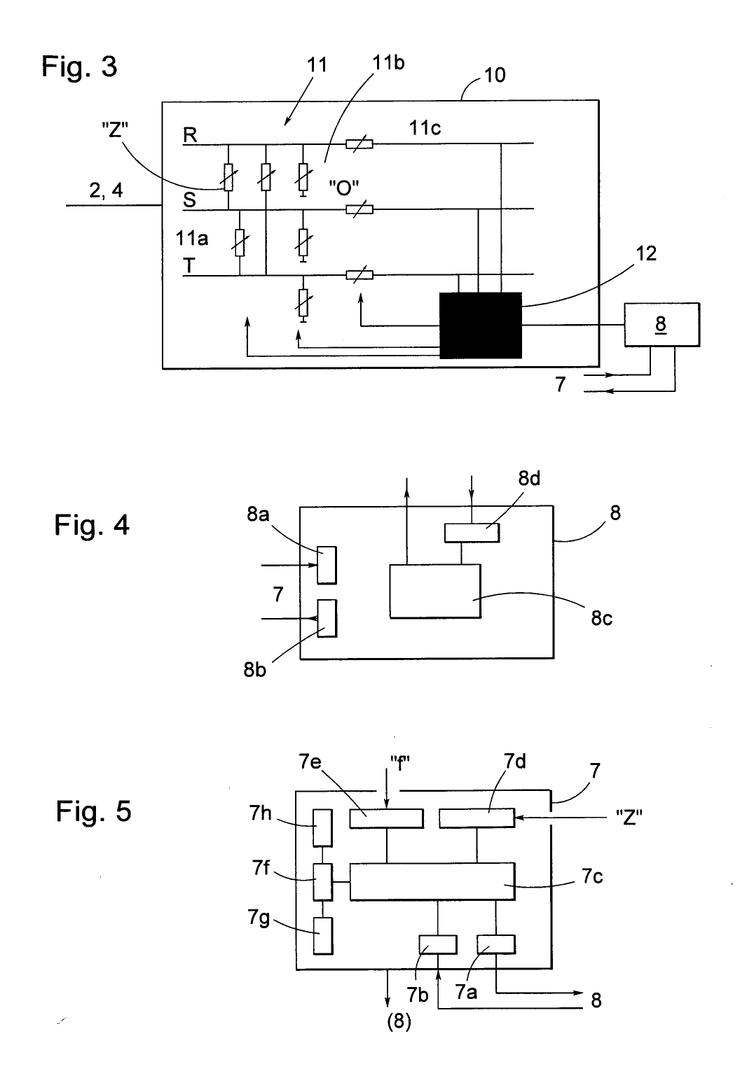

Thus said arrangement 10 does not only include a circuit 11, as shown in FIG. 3, but also its control circuit 12 and may also include said control means 8.

Even further single lines in the Figures are to be interpreted as two-ways signal-transmitting lines.

With reference to FIG. 1 there is illustrated said control means 8, which are related to said arrangement 10 and said circuit 11, the components of which circuit is more closely illustrated in FIG. 3.

Said control means 8 is adapted to control one or more dynamic components “Z”, corresponding to one or more of said primary parameters, by changing the values of said one or more dynamic components in dependence of momentary voltage and/or current values detected at said consumer means 3 and/or adjacent said means and/or adjacent a utilized transformer unit 5.

More specifically said arrangement 10, with the circuits or means 11, 12; 7 and 8, are adapted to dynamically change and tune the resonance frequency of the power transmission cable 1a to avoid any power transmission blocking.

The term “blocking” is to be understood as conditions in the transmission line 1, with its utilized transformer units 4, 5 and other equipment, where the power transmission is blocked or stopped for one reason or another.

Said circuit 11 is thus adapted to cause or generate phase angle compensation, to reduce power loss related to the transmitting cable 1a and associated circuits 4, 11, 5 and 3, the cable 1a is here divided into a land- and/or a surface-related cable section 1a″ and a submarine-related cable section 1a″.

Said circuit 11 is further adapted to cause or generate maintenance of a minimum voltage level or a predetermined voltage level at said consumer means 3, even during a suddenly appearing load variation in said motor 3a.

Control circuits or means 12 in said arrangement 10 includes voltage and/or current sensing means adapted to sense said voltage and/or current at or adjacent said consumer means 3 and responsive to a control signal generated by said main control means 7 to control and set the value of one or more impedance exposing components 11a, 11b and 11c within said circuit 11.

The sensing of said voltage and/or current values, as in FIG. 1, is illustrated adjacent a transformer unit 5 or adjacent said receiving means 3. The arrangement 10 and its control means 12 as well as control means 8 are adapted to refer back to the main control means 7 the result of a given instruction, and thus to form a closed loop arrangement.

Said impedance exposing components 11a, 11b and 11c within said circuit 11 or arrangement 10 are, as illustrated in FIG. 3, connected to phase lines (R, S, T) or conductors in a three-phase transmission cable, between said phase lines, to each phase and zero (or ground) potential “O” and/or in series with said three phase lines.

These components are here designated by the same reference sign “Z”, in order to indicate the dynamic effect that is linked to these components as primary parameters by changing individually said active and dynamic components in a proper way.

The forming of these components “Z” is previously known in the prior art mentioned in the introductory part of the application.

Said control circuits or means 8, 12 comprises further circuit components adapted to determine relevant voltages and/or current values related to said consumer means 3.

Said submarine cable system “S” thus includes frequency converter means 2b as said variable speed drive means 2a; a main control means 7, including memories and computer arrangements as illustrated in FIG. 5, connected to said frequency converter means 2b; a land based or surface (topside) based transformer unit 4; a submarine control means 8 connected to said land based or surface or topside control means 7 to receive information-carrying signals from said main control means 7 and to send information-carrying signals to said main control means; the submarine arrangement 10 and related circuits 11 for compensation for resonance frequencies; a submarine orientated transformer unit 5; and submarine orientated consumer means 3, in the form of a motor 3a.

Said motor 3a has a number of revolutions depending on applied load and voltage and relevant frequency.

FIG. 4 is a simplified block diagram representing a part of said control means 8 related to said arrangement 10 and its circuit 11.

Said control means 8 is here shown with receiving and sending circuits 8a, 8b and includes a signal processing module 8c.

Said module 8c cooperates with an information-carrying path with said arrangement 10 and said circuit 11 and has a circuit 8d for sensing and/or detecting a relevant voltage and/or current value, especially at said motor 3a.

FIG. 5 is a simplified block diagram representing a main control means 7 related to said variable speed drive means 2a.

This control means 7 comprises receiving and transmitting circuits 7a, 7b and a control module 7c.

A circuit 7d is adapted to sense or calculate the relevant impedance value “Z” and to take that value available to said control module 7c.

A circuit 7e is adapted to sense or calculate the relevant frequency value “f” related to said frequency converter means 2b.

Said control module 7c is further to ensure that the information carrying signals sent to control means 8 will not coincide with the maximum or minimum values of the impedance value or relevant value for said transmission line or cable 1a.

In FIG. 5 said control module 7c is controlled by a computer arrangement 7f with a program memory circuit 7g and memory circuits 7h.

FIG. 5 also indicates that one and the same main control means 7 may be used for information exchange with other control means (8) similar to the means 8 as shown and described.

FIG. 2 shows a graph of the impedance variation “Z” in relation to frequency “f” variations for a submarine cable, utilized in the present invention and illustrating impedance-max and impedance-min at different specific frequency values.

The changing of the system related resonance frequency is here caused by changing one or more of the primary parameters. This may be continuously executed, based upon basic frequency set-point and/or local closed loop control measuring, to active and reactive power, which may be combined with voltage, current and phase measurement.

The resonance tuning may be combined with phase compensation to reduce losses and a voltage regulating system, via said arrangement 10, to maintain a sufficient voltage level at the consumer means 3 to avoid stalling effect during variable loads (Slugs).

The tuning of said circuit 11 may be achieved by mechanical adjustment of the components, such as by means of a motor, by electrically controlled components or by fully electronic equipment, creating or causing virtual changes of the primary parameters and their components.

In a subsea application it will be important to use power components and covers that can be pressure compensated. Such equipments are already available.

The present invention is naturally not restricted to the embodiment disclosed by way of example above but may be subject to modifications without departing from the inventive concept as disclosed in the appended claims.

In particular, it should be observed that the individual illustrated units and/or circuits may be combined with each of the other shown units and/or circuits without departing from the scope of the invention in order to be able to attain the desired technical function.

1. An arrangement related to an offshore system including cables and transformer units, said system being adapted for electric power transmission from a power supply comprising a variable speed drive to a consumer comprising an electric motor, over a power transmission line comprising an offshore cable comprising a circuit configured to carry out at least one of compensating for or reducing generated resonance frequencies in dependence of said speed drive; a transmission cable; the length of said cable and any utilized transformer units being adapted to at least one of said transmission line; the consumer or a chosen frequency; said circuit being adapted to enclose at least one primary parameter comprising at least one of resistance, capacitance or inductance values and thereto related components, a control unit is related to said circuit, said control control unit being adapted to control and adjust at least one dynamic component corresponding to at least one of said primary parameters, by changing the value of said at least one dynamic component in dependence of at least one of momentary voltage or current values detected at least one of said consumer or adjacent said consumer or said circuit in order to achieve dynamic resonance tuning and voltage regulation, in dependence of a momentary load situation and/or voltage stabiliztion.

2. The arrangement according to claim 1, wherein said circuit is adapted to change the resonance frequency of the power transmission cable to avoid a power transmission blocking.

3. The arrangement according to claim 1, wherein said circuit is adapted to cause dynamic phase compensation to reduce power loss related to the transmitting cable and associated circuits.

4. The arrangement according to claim 1, wherein said circuit is adapted to cause maintenance of a minimum voltage level at said consumer even during a sudden load variation.

5. The arrangement according to claim 1, wherein said control includes at least one of a voltage or a current sensor adapted to sense at least one of said voltage or current at or adjacent to said consumer and responsive to a control signal generated by a main control unit to control and set the value of one or more impedance exposing components within said circuit.

6. The arrangement according to claim 1, wherein said impedance exposing components within said circuit are connected between phase lines or conductors, in a three-phase transmission cable, between each phase and zero potential and/or in series with said three-phase lines.

7. The arrangement according to claim 1, wherein said control unit exposes circuit components adapted to determine at least one of actual voltages or current values related to said consumer.

8. The arrangement according to claim 1, wherein said offshore cable system comprises a frequency converter as said variable speed drive; a main control unit including memory units and computer arrangements, connected to said frequency converter; a first transformer unit; an offshore control unit connected to said main control unit to receive information-carrying signals from said main control unit and to send information-carrying signals to said main control unit; circuits for compensation for resonance frequencies; a second transformer unit; and said consumer comprising a motor.

9. The arrangement according to claim 1, wherein said motor is adapted to expose a number of revolutions depending on applied load and voltage and relevant frequency.
